(19) United States
(12) Patent Application Publication
(10) Pub. No.: US 2022/0317427 A1
(43) Pub. Date: Oct. 6, 2022

(54) IMAGING LENS, IMAGING DEVICE AND IMAGING SYSTEM

(71) Applicant: BOE Technology Group Co., Ltd., Beijing (CN)

(72) Inventors: Fang CHENG, Beijing (CN); Tao HONG, Beijing (CN); Lei ZHANG, Beijing (CN); Tianyang HAN, Beijing (CN)

(21) Appl. No.: 17/299,427

(22) PCT Filed: Sep. 15, 2020
(86) PCT No.: PCT/CN2020/115430

§ 371 Date: Jun. 3, 2021

(51) Int. Cl. G02B 17/08; G02B 13/00

(52) U.S. Cl. CPC G02B 17/08; G02B 13/0015; G02B 13/0065

(57) ABSTRACT

Disclosed in embodiments of the present disclosure are an imaging lens, an imaging device and an imaging system, including: a lens body, including: a first optical surface and a second optical surface arranged in sequence along an incident direction of light; the first optical surface includes: an annular light incident area, for transmitting incident light; and at least one first annular reflection area, surrounding the first annular reflection area; the second optical surface includes: a light emitting area, for transmitting emitted light; and at least one second annular reflection area, surrounding the light emitting area; the incident light is incident into the lens body through the annular light incident area, is reflected for a plurality of times between the at least one second annular reflection area and the at least one first annular reflection area in sequence, and is emitted outwards from the lens body through the light emitting area.

### CROSS REFERENCE TO RELATED APPLICATIONS

The present disclosure is a National Stage of International Application No. PCT/CN2020/115430, filed Sep. 15, 2020.

### FIELD

The present disclosure relates to the technical field of imaging, in particular to an imaging lens, an imaging device and an imaging system.

### BACKGROUND

With the development of electronic technology, portable electronic devices have gradually emerged, and portable electronic products with camera function have become more popular.

At present, miniaturization and lightweight have become an obvious development trend of portable electronic products. At the same time, the imaging lenses used in electronic products also need to meet the requirements of product miniaturization.

The imaging lens used in electronic products at this stage usually uses the lens group structure. In order to meet the imaging requirements, the axial dimension of the imaging lens is relatively large, which cannot meet the design requirements of miniaturization and lightweight.

### SUMMARY

Embodiments of the present disclosure provide an imaging lens, including:

a lens body, including: a first optical surface and a second optical surface arranged in sequence along an incident direction of light;

the first optical surface includes: an annular light incident area, for transmitting incident light; and at least one first annular reflection area, surrounding the first annular reflection area;

the second optical surface includes: a light emitting area, for transmitting emitted light; and at least one second annular reflection area, surrounding the light emitting area;

the incident light is incident into the lens body through the annular light incident area, is reflected for a plurality of times between the at least one second annular reflection area and the at least one first annular reflection area in sequence, and is emitted outwards from the lens body through the light emitting area.

In some embodiments of the present disclosure, the first optical surface is a curved surface, and the second optical surface is a flat surface.

In some embodiments of the present disclosure, an imaging field of view of the imaging lens is a symmetrical field of view;

the at least one first annular reflection area is a centrally symmetrical structure, the at least one second annular reflection area is a centrally symmetrical structure; and a central of symmetry of the orthographic projection of the at least one first annular reflection area on the second optical surface is coincided with a central of symmetry of the at least one second annular reflection area.

In some embodiments of the present disclosure, an imaging field of view of the imaging lens is a non-symmetrical field of view; and

the at least one first annular reflection area is a non-centrally symmetrical structure, and the at least one second annular reflection area is a non-centrally symmetrical structure.

In some embodiments of the present disclosure, an imaging field angle of view of the imaging lens is greater than or equal to 10°.

In some embodiments of the present disclosure, a reflective coating film is disposed in an area, where the first annular reflection area is located, of the first optical surface; and

a reflective coating film is disposed in an area, where the second annular reflection area is located, of the second optical surface.

In some embodiments of the present disclosure, a quantity of the first annular reflection area is equal to a quantity of the second annular reflection area.

In some embodiments of the present disclosure, the quantity of the first annular reflection area ranges from 1 to 9, and the quantity of the second annular reflection area ranges from 1 to 9.

In some embodiments of the present disclosure, an internal diameter dimension of the annular light incident area and an external diameter dimension of the annular light incident area satisfy a relationship as follows:

0.5≤α≤1;

α represents a ratio of the internal diameter dimension of the annular light incident area to the external diameter dimension of the annular light incident area.

In some embodiments of the present disclosure, a maximum thickness of the imaging lens along an optical axis direction is less than or equal to 2 mm;

a maximum size of the imaging lens along a direction vertical to the optical axis direction is less than or equal to 7 mm; and

a focal length of the imaging lens is less than or equal to 10 mm.

In some embodiments of the present disclosure, a material of the lens body is polymethyl methacrylate.

In some embodiments of the present disclosure, a working band of the imaging lens is a visible light band.

In some embodiments of the present disclosure, the first optical surface includes one of the first annular reflection area, and the second optical surface includes one of the second annular reflection area.

In some embodiments of the present disclosure, a surface shape of the annular light incident area and a surface shape of first annular reflection area both satisfy a relationship as follows:

$$z = \frac{c {r}^{2}}{1 + \sqrt{1 - ( 1 + k ) {c}^{2} {r}^{2}}} + {\sum }_{i = 1}^{n} {α}_{i} {r}^{2 i} ;$$

c represents a radius of a base sphere; k represents a constant of a conic curve; r represents a distance between any point in the annular light incident area or the first annular reflection area of the first optical surface and an aspherical axis; z represents a vertical distance corresponding to the any point in the annular light incident area or the first annular reflection area of the first optical surface, and the vertical distance is a distance between the any point in the annular light incident area or the first annular reflection area of the first optical surface and a tangent plane of a the base sphere, closest to the any point, at a position at which the aspherical axis is intersected with the base sphere; αᵢ represents a coefficient, and n represents a positive integer; and the aspherical axis is coincided with an optical axis.

In some embodiments of the present disclosure, for the surface shape of the annular light incident area:

k=−0.6040;

α1=0;

α2=0.0054;

α3=−0.0038;

α4=0.0070;

α5=−0.0053;

α6=0.0019;

α7=−0.0003;

for the surface shape of the first annular reflection area:

k=7.19;

α1=0;

α2=−0.0207;

α3=0.0235;

α4=−0.1775;

α5=0.5615;

α6=−0.8856;

α7=0.5490.

In some embodiments of the present disclosure, a radius of the base sphere of the annular light incident area is 2.00 mm; and a radius of the base sphere of the first annular reflection area is 11.21 mm; a vertical distance a1 between a point on the equation Z=0 of the surface shape of the annular light incident area and the second optical surface is 1.81 mm; a vertical distance between a point on the equation z=0 of the surface shape of the first annular reflection area and the second optical surface is 1.74 mm; and a maximum size of the imaging lens along a direction vertical to the optical axis is 2.8 mm; and a focal length of the imaging lens is 4 mm.

Embodiments of the present disclosure further provide an imaging device, including:

an annular diaphragm, for limiting an incident range of light;

the imaging lens disclosed in embodiments of above, disposed on a side of the annular diaphragm and used for imaging; and

an optical detector, disposed on a side, facing away from the annular diaphragm, of the imaging lens, and configured to receive imaging light.

Embodiments of the present disclosure further provide an imaging system, including a plurality of the above imaging devices arranged in an array.

In some embodiments of the present disclosure, imaging field angles of view of any two of the plurality of imaging devices are different, and the imaging field angles of view of adjacent imaging devices are continuous with each other; or, the imaging field angles of view of each of the plurality of imaging devices are the same, or the imaging field angles of view of at least two of the plurality of imaging devices are different.

### BRIEF DESCRIPTION OF THE DRAWINGS

In order to more clearly illustrate the technical solutions of embodiments of the present disclosure, figures to be used in embodiments of the present disclosure will be introduced simply below. Obviously, the figures introduced below are merely some embodiments of the present disclosure, and other figures can be obtained according to these drawings by those of ordinary skills in the art without any creative effort.

FIG. 1 is a structural schematic diagram of a side view of an imaging lens provided in embodiments of the present disclosure.

FIG. 2 is a structural schematic diagram of a top view of an imaging lens in FIG. 1.

FIG. 3 is another structural schematic diagram of a side view of an imaging lens provided in embodiments of the present disclosure.

FIG. 4 is a diagram of a light path of an imaging lens provided in embodiments of the present disclosure.

FIG. 5 is a diagram of relationship between the thickness and focal length of an imaging lens provided in embodiments of the present disclosure.

FIG. 6 is another diagram of relationship between the thickness and focal length of an imaging lens provided in embodiments of the present disclosure.

FIG. 7 is another diagram of relationship between the thickness and focal length of an imaging lens provided in embodiments of the present disclosure.

FIG. 8A is another structural schematic diagram of a side view of an imaging lens provided in embodiments of the present disclosure.

FIG. 8B is another structural schematic diagram of a side view of an imaging lens provided in embodiments of the present disclosure.

FIG. 9 is a curve chart of an optical transfer function of an imaging lens shown in FIG. 8A.

FIG. 10 is a spot diagram of an imaging lens shown in FIG. 8A.

FIG. 11 is a field curvature diagram of an imaging lens shown in FIG. 8A.

FIG. 12 is a distortion diagram of an imaging lens shown in FIG. 8A.

FIG. 13 is a structural schematic diagram of an imaging device provided in embodiments of the present disclosure.

FIG. 14 is a structural schematic diagram of a top view of an imaging system provided in embodiments of the present disclosure.

### DETAILED DESCRIPTION OF THE EMBODIMENTS

In order to make the above objectives, features and advantages of the present disclosure more apparent and understandable, the present disclosure will be further described below in combination with the figures and embodiments. However, the exemplary embodiments can be implemented in a variety of forms and should not be construed as being limited to embodiments set forth herein; on the contrary, these embodiments are provided to make the present disclosure more comprehensive and complete and communicate the ideas of the exemplary embodiments to those skilled in the art in a comprehensive manner. Identical reference numerals in the figures indicate identical or similar structures, and therefore repetitive descriptions of them will be omitted. The words expressing position and orientation described in the present disclosure are illustrated with the figures as examples, but changes may be made as needed, and any changes made are included in the protection scope of the present disclosure. The figures of the present disclosure are used merely to show the relative position relationship and do not represent the true proportion.

The optical lens is an essential part of the imaging system, and the optical lens is an optical device which has a deflecting effect on light and which is set using the law of reflection and the law of refraction of light.

With the popularity of electronic devices, the imaging technology applied in mobile electronic devices has been rapidly developed and progressed. At present, miniaturization and lightweight have become the obvious development trend of portable electronic products. At the same time, the imaging lens used in electronic products also needs to adapt to the requirements of product miniaturization.

In order to optimize the imaging of an optical system, an imaging lens usually consists of a plurality of lenses and a lens barrel, wherein each lens is mounted independently in a predetermined position in the lens barrel, and the positional relationship between the lenses is fixed. However, each lens is individually manufactured during the manufacturing process, and the lenses are assembled after manufacturing, to facilitate the formation of a predetermined light path between the lenses.

Lenses inevitably bring in tolerances during installation, thereby making it necessary to adjust the lenses at the end of installation. The axial dimension of the lens consisting of a plurality of lenses is large, and to achieve the requirements of miniaturization and lightweight, the design difficulty is also increased.

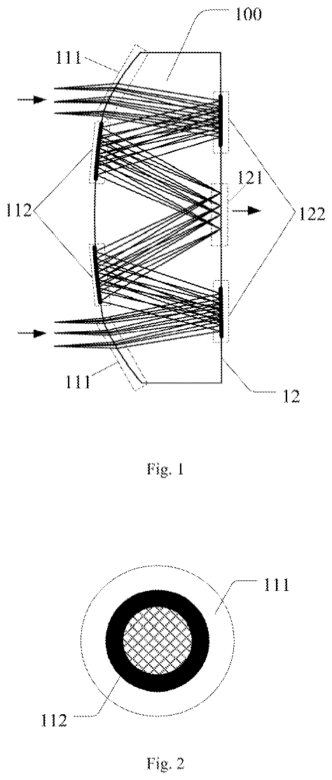

FIG. 1 is a structural schematic diagram of a side view of an imaging lens provided in embodiments of the present disclosure.

As shown in FIG. 1, the imaging lens provided in embodiments of the present disclosure only includes one lens. The lens includes a lens body 100. The lens body 100 can be made of optical plastics, such as polymethyl methacrylate (PMMA). The lens body 100 can be produced by injection molding in one time.

The working band of the above imaging lens provided in embodiments of the present disclosure is visible light band. The imaging lens can be applied to small portable devices like digital cameras and mobile phones.

The lens body 100 includes: a first optical surface 11 and a second optical surface 12 arranged in sequence along the incident direction of light.

In embodiments of the present disclosure, the external contour of the first optical surface 11 and the second optical surface 12 can be circular.

FIG. 2 is a structural schematic diagram of a top view of a first optical surface provided in embodiments of the present disclosure.

Refer to FIG. 1 and FIG. 2, the first optical surface 11 includes: an annular light incident area 111 and at least one first annular reflection area 112.

The annular light incident area 111 is arranged on the outermost side of the first optical surface 11, and is configured to transmit incident light.

The annular light incident area 111 surrounds the first annular reflection area 112, when the first optical surface 11 includes a plurality of first annular reflection areas 112, the annular apertures of the first annular reflection areas 112 can be different, and the first annular reflection areas 112 are nested with each other. The second optical surface 12 is set to be opposite to the first optical surface 11, and the second optical surface 12 includes: a light emitting area 121 and at least one second annular reflection area 122.

The light emitting area 121 is arranged in the central of the second optical surface 12, and is configured to transmit emitted light.

The second annular reflection area 122 surrounds the light emitting area 121, when the second optical surface 12 includes a plurality of second annular reflection areas 122, the annular apertures of the second annular reflection areas 122 are different, and the second annular reflection areas 122 are nested with each other.

Refer to the light path as shown in FIG. 1, in some embodiments, the incident light is incident into the lens body 100 through the annular light incident area 111, is reflected for a plurality of times between the at least one second annular reflection area 122 and the at least one first annular reflection area 112 in sequence, and is finally emitted outwards from the lens body through the light emitting area 121.

In some embodiments, the imaging lens only adopts one lens, thereby simplifying the processing procedure and lowering the complexity of lens assembly. The imaging lens can reduce the optical length of the optical system using multiple-reflections to refold the optical path, thereby significantly reducing the axial dimension of the imaging lens, and making the imaging lens have the characteristics of ultra-thinness and simple and compact structure.

Refer to FIG. 1, in some embodiments of the present disclosure, the first optical surface 11 is a curved surface, and the second optical surface 12 is a flat surface.

One optical surface of the imaging lens is set to be a flat surface, then the processing difficulty can be greatly reduced, and when the other optical surface is set to be a curved surface, in combination with the reflection between the first optical surface 11 and the second optical surface 12, the imaging requirement of the imaging lens can be satisfied.

Refer to FIG. 1. In some embodiments, a coating film manner can be adopted to make the set area of the first optical surface 11 and the set area the second optical area 12 are reflective. In some embodiments, a reflective coating film can be arranged in the area, corresponding to the area in which the first annular reflection area 112 is located, on the outer side of the first optical surface 11; and a reflective coating film can be arranged in the area, corresponding to the area in which the second annular reflection area 122 is located, on the outer side of the second optical surface 12.

In some embodiments, the annular light incident area 111 of the first optical surface 11 is configured to receive incident light, and the second annular reflection area 122 of the second optical surface 12 is configured to receive incident light and reflect towards the first annular reflection area 112 of the first optical surface 11; and the first annular reflection area 112 of the first optical surface 11 is configured to receive reflected light from the second annular reflection area 122 and reflect towards the light emitting area 121 of the second optical surface 12. Therefore, light is incident into the inside of the lens body from the annular light incident area 111, and then is incident onto the second annular reflection area 122, light is reflected by the second annular reflection area 122, light is reflected onto the first annular reflection area 112, light is then reflected by the first annular reflection area 112, and the reflected light is finally emitted through the light emitting area 121.

In some embodiments, as shown in FIG. 1, the imaging field of view of the imaging lens can be a symmetrical field of view. The annular light incident area 111 on the first optical surface 11 can be set to have a centrally symmetrical structure, and the annular light incident surface 111 can be set to have a circular ring structure.

Each first annular reflection area 112 surrounded by the annular light incident area 111 can also be set to have a centrally symmetrical structure, and the orthographic projection of each first annular reflection area 112 on the second optical surface 12 is a concentric ring structure whose diameters sequentially expand from the center to the edge.

The annular light incident area 111 and the first annular reflection area 112 are concentric rings. The optical axis of the annular light incident area 111 is coincided with the optical axis of each first annular reflection area 112.

Similarly, the light emitting area 121 on the second optical surface 12 can be set to be a centrally symmetrical structure, and the light emitting area 121 can be set to be a circular structure.

Each second annular reflection area 122 surrounding the light emitting area 121 can also be set to have a centrally symmetrical structure, and each second annular reflection area 122 is a concentric ring structure whose diameters sequentially expand from the center to the edge.

The optical axis of each second annular reflection area 122 is coincided with the optical axis of the light emitting area 121.

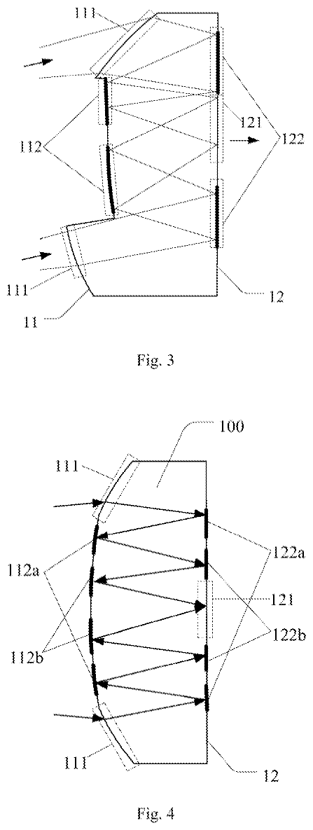

FIG. 3 is another structural schematic diagram of a side view of an imaging lens provided in embodiments of the present disclosure.

Refer to FIG. 3. In some embodiments, the imaging field of view of the imaging lens can also be non-symmetrical field of view. The annular light incident area 111 on the first optical surface 11 is a non-centrally symmetrical structure, each first annular reflection area 112 is a non-centrally symmetrical structure, and the orthographic projection of each first annular reflection area 112 on the second optical surface 12 is a non-centrally symmetrical structure.

Each second annular reflection area 122 on the second optical surface 12 is a non-centrally symmetrical structure.

In some embodiments, imaging lenses with symmetric imaging field of view and imaging lenses with asymmetric imaging field of view can be spliced and combined with each other, to achieve the effect of a larger imaging field of view through the field of view splicing.

In some embodiments, when optical design is performed, the range of the field angle of view of the imaging lens can be greater than or equal to 10°. For example, the field angle of view of the imaging lens with a symmetrical imaging field of view can be −5° to 5°; while the field angle of view of the imaging lens with an asymmetrical imaging field of view can be 5° to 15°. In addition, the imaging lens can also have an imaging field of view in a larger range, which is not limited herein.

In some embodiments, with the first optical surface of the imaging lens including two first annular reflection areas and the second optical surface including two second annular reflection areas as an example, the foldback process of the light path of the imaging lens provided in embodiments of the present disclosure is described.

FIG. 4 is a schematic diagram of a light path of an imaging lens provided in embodiments of the present disclosure.

Refer to FIG. 4. The first optical surface 11 includes: an annular light incident area 111, and two first annular reflection areas (112a and 112b) surrounded by the annular light incident area 111; and the second optical surface 12 includes: a light emitting area 121 and two second annular reflection areas (122a and 122b) surrounding the light emitting area 121.

The light is incident from the annular light incident area 111 to the inside of the lens and is then incident towards the second annular reflection area 122a, and the second annular reflection area 122a reflects the incident light towards the first annular reflection area 112a; the first annular reflection area 112a receives the reflected light from the second annular reflection area 122a, and reflects the light towards the second annular reflection area 122b; the second annular reflection area 122b receives the reflected light from the first annular reflection area 122a, and reflects the light towards the first annular reflection area 112b; and the first annular reflection area 112b receives the reflected light from the second annular reflection area 122b, and reflects the light towards the light emitting area 121, and finally the light is emitted outwards from the light emitting area 121.

In some embodiments, the number of the first annular reflection areas 112 included in the first optical surface 11 is equal to the number of the second annular reflection areas 122 included in the second optical surface 12. Therefore, it can be ensured that, when the light is incident into the lens body, the first reflection is the reflection through the second annular reflection area of the second optical surface, while the last reflection is the reflection through the first annular reflection surface of the first optical surface, then the light can be finally emitted outwards from the light emitting area 121 of the second optical surface 12.

In some embodiments, along a sequence from the edge to the center of the lens body, one first annular reflection area 112 corresponds to one second annular reflection area 122, and the second annular reflection area 122 will reflect the incident light to the corresponding first annular reflection area 112.

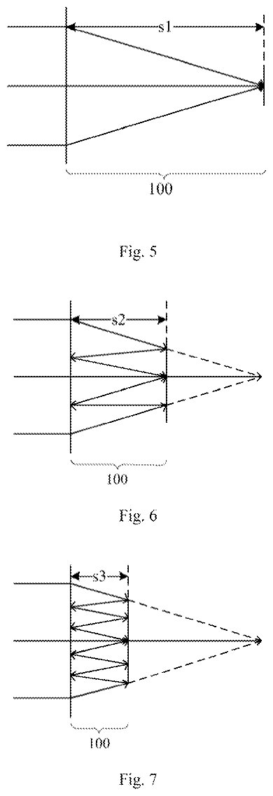

FIGS. 5-7 are schematic diagrams of relationship between thickness and focal length of the imaging lens provided in embodiments of the present disclosure.

Refer to FIG. 5. The imaging lens adopts a transmission light path, when the dielectric material adopted by the imaging lens is an optical plastic, suppose the refraction index of the optical plastic is 1.5, then the thickness s1=nf. And, n represents the refraction index of the material adopted by the imaging lens, and f represents the focal length of the imaging lens.

Refer to FIG. 6, when the imaging lens adopts a reflection light path, and the dielectric material adopted by the imaging lens is still an optical plastic, and when the focal length is unchanged, after one foldback of the light path of the imaging lens, the thickness s2 of the imaging lens is reduced. It can be seen in comparison with FIG. 5 and FIG. 6 that, s2=s1/2.

Refer to FIG. 7, when the imaging lens adopts a reflected light path, and the dielectric material adopted by the imaging lens is still the optical plastic, and when the focal length is unchanged, after foldback of the light path of the imaging lens for twice, the thickness s3 of the imaging lens is further reduced. In comparison with FIG. 6 and FIG. 7, it can be seen that, s3=s2/2.

Therefore, it can be seen that, when the imaging lens adopts a reflected light path, and when the focal length is unchanged, the more the times of foldback of the light path in the imaging lens, the smaller the axial dimension of the imaging lens, that is, the thickness of the imaging lens is smaller.

In some embodiments, the thickness and the number of foldback of the imaging lens satisfy the following relationship:

$$s = \frac{f \times n}{N} ;$$

s represents the thickness of the imaging lens along an optical axis, f represents the focal length of the imaging lens, n represents the refractive index of the material adopted by the imaging lens, and N represents the number of reflection of light within the imaging lens.

According to the above formula, in combination with the design of thickness of imaging lens in practical application, the number of reflection of light in the imaging lens can be calculated, so as to perform optimal design on the surface shape of the imaging lens.

In some embodiments, the reflection process in which light is reflected by a second annular reflection area and a first annular reflection area in sequence is called one foldback.

In some embodiments, the maximum thickness of the imaging lens along the optical axis is less than or equal to 2 mm, the focal length of the imaging lens is less than or equal to 10 mm, and the maximum size of the imaging lens along the direction vertical to the optical axis is less than or equal to 7 mm. According to the above requirements, the number of foldback within the imaging lens can be determined in combination with the above formula, thereby determining the number of the first annular reflection areas 112 included in the first optical surface and the number of the second annular reflection areas 122 included in the second optical surface.

Setting the axial dimension and radial dimension of the imaging lens to be within the above range can meet the design requirements of miniaturization and lightweight of the imaging lens. According to the relationship between the focal length and thickness satisfied by the imaging lens, the number of the first annular reflection area 121 included in the first optical surface 11 can be set to 1-9, and the number of the second annular reflection area 122 included in the second optical surface 12 can be set to 1-9.

In some embodiments, the imaging lens transmits light only at the edge position, and blocks light in the center, that is, the size of the annular light incident area 111 affects the size of the light transmitting area of the imaging lens, so the size of the annular light incident area 111 needs to be appropriately increased to ensure the effective aperture of the imaging lens.

In some embodiments, the internal diameter dimension of the annular light incident area 111 and the external diameter dimension of the annular light incident area 111 satisfy the following relationship:

D_{eff}=D\sqrt{1−α²};

D_{eff} represents the effective aperture of the imaging lens, that is, the aperture of the light incident area of the imaging lens; D represents the external diameter dimension of the annular light incident area, and a represents the obscuration ratio of the imaging lens, that is, the ratio of the internal diameter dimension to the external diameter dimension of the annular light incident area.

The ratio α of the internal diameter dimension to the external diameter dimension of the annular light incident area can directly affect the imaging brightness. If the value of α is too small, the amount of incident light is limited, and the imaging cannot be guaranteed to have a high brightness for the optical detector to detect the light signal; if the value of α is too large, the setting area of the annular reflection surface will be compressed and the design of the lens becomes more difficult. Therefore, in some embodiments, the ratio α of the internal diameter dimension to the external diameter dimension of the annular light incident area is set to be in the range of 0.5-1, which can ensure that the imaging of the imaging lens meets the design requirements.

In some embodiments, the imaging lens adopts the design of a reflective light path, and the second annular reflection area and the first annular reflection area reflect the incident light for a plurality of times to fold the light path, thereby reducing the length of the entire imaging system, and making the imaging system ultra-thin, compact in structure, and easy to process, etc. The design parameters of the imaging lens provided in embodiments of the present disclosure are described below with an imaging lens only including one first annular reflection area and one second annular reflection area as an example.

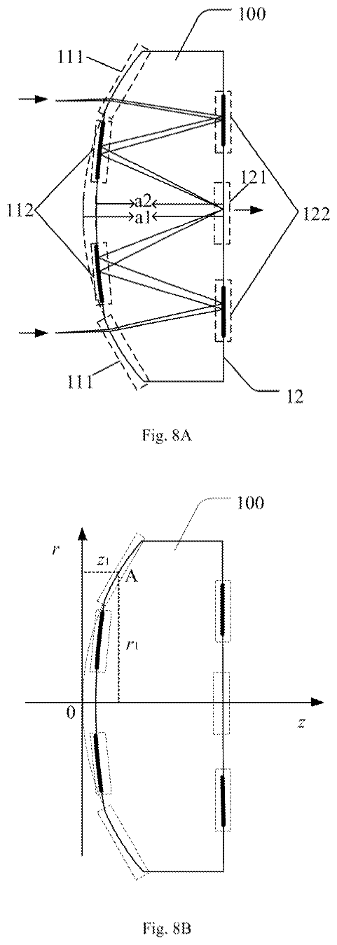

FIG. 8A and FIG. 8B are structural schematic diagrams of a side view of an imaging lens provided in embodiments of the present disclosure, and the optical axis of the imaging lens is on the cross section.

Refer to FIG. 8A, in the imaging lens provided in embodiments of the present disclosure, the first optical surface 11 is a curved surface, the second optical surface 12 is a flat surface, the first optical surface 11 includes a first annular reflection area 112, and the second optical surface 12 includes a second annular reflection area 122.

When parameters of the first optical surface 11 are optimized, the annular light incident area 111 and the first annular reflection area 112 of the first optical surface can both select an aspherical surface shape, and compared with a spherical surface shape, the aspherical surface shape can optimize more comprehensive parameters, therefore, the imaging quality is better.

In some embodiments, the annular light incident area 111 and the first annular reflection area 112 can be designed as any one of an odd aspheric surface, an even aspheric surface or a free curved surface. The odd aspheric surface is an asymmetric aspheric surface and the even aspheric surface is a symmetric aspheric surface. In consideration of the processing difficulty, in some embodiments, the annular light incident area 111 and the first annular reflection area 112 can be designed as an even aspheric surface.

In some embodiments, the surface shape of the annular light incident area 111 and the surface shape of the first annular reflection area 112 both satisfy the following relationship:

$$z = \frac{c {r}^{2}}{1 + \sqrt{1 - ( 1 + k ) {c}^{2} {r}^{2}}} + {\sum }_{i = 1}^{n} {α}_{i} {r}^{2 i} ;$$

c represents the radius of the base sphere; k represents a constant of a conic curve; r represents the distance between any point in the annular light incident area 111 or any point in the first annular reflection area 112 of the first optical surface 11 and the aspherical axis; z represents the vertical distance corresponding to the any point in the annular light incident area 111 or the any point in the first annular reflection area 112 of the first optical surface 11, and the vertical distance is the distance between the any point in the annular light incident area 111 or the any point in the first annular reflection area 112 of the first optical surface 11 and the tangent plane of the base sphere, closest to the any point, at the position at which the aspherical axis is intersected with the base sphere; αᵢ represents a coefficient, and n represents a positive integer; and the aspherical axis is coincided with the optical axis. The relationship of change of z along with r represents the equation of the surface shape of the annular light incident surface. FIG. 8B shows that the distances from any point A in the annular light incident area 111 on the first optical surface 11 to the r axis and the z axis are respectively r1 and z1; r-axis is coincided with the aspherical axis, and is also coincided with the optical axis of the imaging lens; and the z-axis and the aspheric axis coincide with the projection of the base sphere tangent plane at the cross section at the position of the base sphere intersection.

The value of k can affect the surface shape of the optical surface. αᵢ is the coefficient of the higher order term, and the more the number of higher order terms (i.e., the larger the value of n), the finer the design. When optical design is performed, the imaging quality of the annular light incident area 111 and the first annular reflection area 112 can be optimized by increasing the number of higher order terms.

When the surface shape of the annular light incident area 111 satisfies the above formula, the value of each parameter is as follows:

k=−0.6040;

α1=0;

α2=0.0054;

α3=−0.0038;

α4=0.0070;

α5=−0.0053;

α6=0.0019;

α7=−0.0003.

When the surface shape of the first annular reflection area 112 satisfies the above formula, the value of each parameter is as follows:

k=7.19;

α1=0;

α2=−0.0207;

α3=0.0235;

α4=−0.1775;

α5=0.5615;

α6=−0.8856;

α7=0.5490.

It can be seen that, the surface shape of the annular light incident area 111 and the surface shape of the first annular reflection area 112 are not the same, and the parameters of the above curved surfaces can be optimized by considering the performance of the field curvature, distortions, and optical transfer functions.

In the optical design, the annular light incident area 111 and the first annular reflection area 112 can also select an odd aspheric surface or a free curved surface. Embodiments of the present disclosure are exemplified by embodiments of the even aspheric surface only, and do not limit the surface shapes of the annular light incident area 111 and the first annular reflection area 112. When other types of surface shapes are selected for the annular light incident area 111 and the first annular reflection area 112, the corresponding parameters should be reset.

Refer to FIG. 8A, after the parameters of the imaging lens are optimized, the radius of the base sphere of the annular light incident area 111 is 2.00 mm, the vertical distance a1 between the point on the equation Z=0 of the surface shape of the annular light incident area 111 and the second optical surface 12 is 1.81 mm; the radius of the base sphere of the first annular reflection surface 112 is 11.21 mm, and the vertical distance a2 between the point on the equation Z=0 of the surface shape of the first annular reflection area 112 and the second optical surface 12 is 1.74 mm; and the second optical surface 12 is a flat surface.

After parameters of the imaging lens are optimized, the maximum size of the imaging lens along the direction vertical to the optical axis is 2.8 mm, and the focal length of the imaging lens is 4 mm.

Therefore, the design requirements of ultra-thin and miniaturized imaging lens can be satisfied.

The imaging performance of the imaging lens shown in FIG. 8A is further detected in embodiments of the present disclosure.

FIG. 9 is a curve chart of an optical transfer function of an imaging lens shown in FIG. 8A, the horizontal coordinate represents the spatial frequency, the vertical coordinate represents the value of the modulation transfer function (MTF for short), and the MTF value is an important parameter reflecting the optical system.

The two curves (F1:Y Diff Lim, F1:X Diff Lim) arranged at the top in FIG. 9 respectively represent the diffraction limit curves corresponding to the arc-vector direction and the meridian direction, X represents the meridian direction and Y represents the arc-vector direction. The diffraction limit curves F1:Y Diff Lim, F1:X Diff Lim are shown with arrows in the figure. It can be seen that the F1:Y Diff Lim, F1:X Diff Lim curves are basically coincided. The values corresponding to the other different curves Fn in FIG. 9 represent the field angle of view in the meridian direction or the arc-vector direction. FIG. 9 shows the MTF curves at different field angles of view. At different field angles of view, the closer the MTF value is to the diffraction limit curve, the better the imaging effect of the imaging system.

It can be seen in FIG. 9 that, as to the imaging lens no matter in the meridian direction or the arc-vector direction, the MTF curve at each field angle of view is close to the diffraction limit, thereby having a favorable imaging performance.

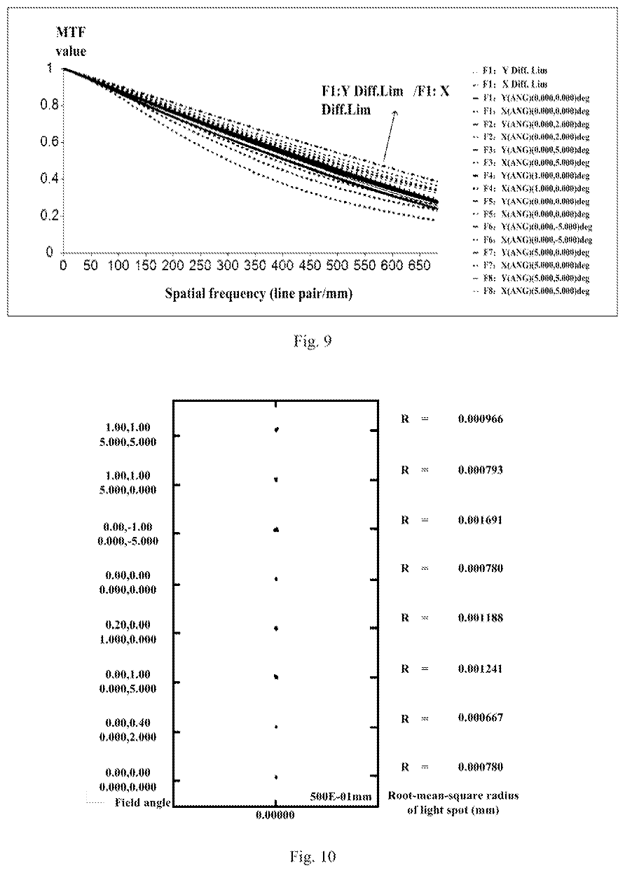

FIG. 10 is a spot diagram of an imaging lens shown in FIG. 8A. The values on the left side in FIG. 10 represent the field angles of view in both X and Y directions. For example, 1.00, 1.00 represents a full field of view of 5° and 5° in both X and Y directions; 1.00, 0.00 represents a full field of view of 5° and 0° in both X and Y directions; 0.20, 0.00 represents a full field of view of 1° and 0° in both X and Y directions, and so on. The value of R on the right side in FIG. 10 represents the root-mean-square radius of the light spot in the spot diagram, i.e., representing the spot size in the unit of millimeter.

FIG. 10 shows the dimensions of the imaging spot at different field-of-view positions. As shown in FIG. 10, the imaging lens provided in embodiments of the present disclosure has smaller root-mean-square radii of the imaging spot at different field angles, and all the root-mean-square radii are less than the pixel size of the optical detector, thereby having better imaging performance.

FIG. 11 is a field curvature diagram of an imaging lens shown in FIG. 8A, the horizontal coordinate represents the amount of field curvature and the vertical coordinate represents the field angle of view. The closer the field curvature of the imaging lens at each field angle of view is to 0, the better the imaging effect. In the field curvature diagram shown in FIG. 11, the amount of field curvature in the arc-vector direction and the meridian direction are shown, the dashed line represents the amount of the field curvature in the arc-vector direction and the solid line represents the amount of the field curvature in the meridian direction. As shown in FIG. 11, the amount of the field curvature of the imaging lens provided in embodiments of the present disclosure is less than 0.1%, and the field curvature is small, and a better imaging effect is achieved.

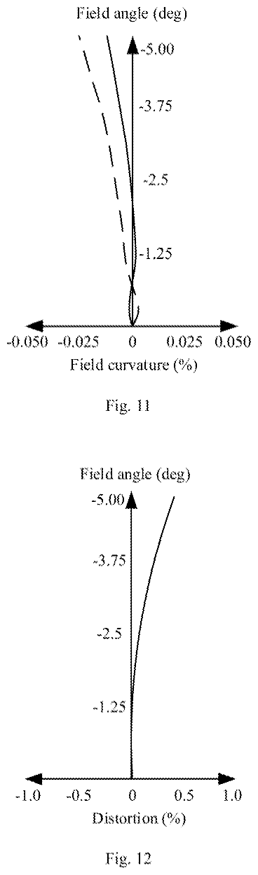

FIG. 12 is a distortion diagram of an imaging lens shown in FIG. 8A, the horizontal coordinate represents the amount of distortion, and the vertical coordinate represents the field angle of view. The closer the amount of field curvature of the imaging lens in each field angle of view is to 0, the better the imaging effect. As shown in FIG. 12, the distortion amount of the imaging lens provided in embodiments of the present disclosure is less than 0.5%, the less the distortion amount, the better the imaging effect.

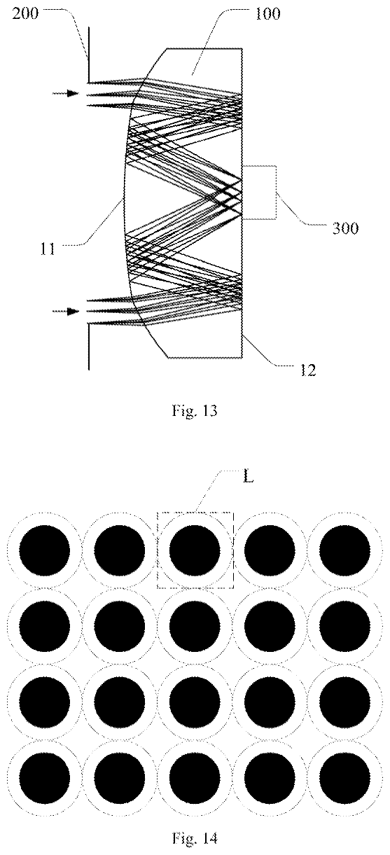

Based on the same inventive concept, embodiments of the present disclosure further provide an imaging device. FIG. 13 is a structural schematic diagram of an imaging device provided in embodiments of the present disclosure.

Refer to FIG. 13. The imaging device provided in embodiments of the present disclosure includes: an annular diaphragm 200, any one of the above imaging lenses 100 and an optical detector 300.

The annular diaphragm 200 is located on the light incident side of the imaging lens 100, and is configured to limit the range of incident light. The annular diaphragm 200 is separated from the imaging lens 100 by a set distance.

The imaging lens 100 is located on a side of the annular diaphragm 200, and light is incident into the imaging lens 100 after passing through the annular diaphragm 200. For the structure of the imaging lens 100, please refer to the above embodiments, which will not be repeated redundantly herein.

The optical detector 300 is located on a side, facing away from the annular diaphragm 200, of the imaging lens 100, and is configured to receive imaging light. The optical detector 300 can be located on the surface of the light emitting area of the imaging lens 100. In this way, light passing through the imaging lens 100 can be directly incident into the optical detector 300.

The principles based on which the above imaging device solves problems are similar to the principles of the above imaging lens, so for the implementation of the imaging device, please refer to the implementation of the above imaging lens, and the repeated parts will not be repeated redundantly herein.

Embodiments of the present disclosure further provide an imaging system. FIG. 14 is a structural schematic diagram of a top view of an imaging system provided in embodiments of the present disclosure.

Refer to FIG. 14, the imaging system provided in embodiments of the present disclosure includes: a plurality of imaging devices L arranged in an array. The imaging system is formed by the plurality of imaging devices L which are arranged according to set rules, and the imaging lens in each imaging device L of the imaging system utilizes a multiple-reflection foldback light path, and has a small axial dimension, such that the imaging lens has the characteristics of ultra-thinness and simple and compact structure. Therefore, the imaging system provided in embodiments of the present invention has the characteristics of ultra-thinness and simple and compact structure.

In some embodiments, the imaging field angle of view of each imaging device L in the imaging system varies, and the imaging field angles of view of adjacent imaging devices are continuous with each other.

For example, the imaging field of view of each imaging device L in the imaging system is greater than or equal to 10°, and the imaging device arranged in the center of the imaging system has an imaging field of view of −5°-5°; and the imaging device adjacent to the imaging device has an imaging field of view of 5°-15°. Then, after arranging the two imaging devices side by side, the imaging field of view of the imaging system can be spliced together to obtain a field of view of −5°-15°.

By analogy, the imaging device arranged in the center of the imaging system is called L0, and the imaging device adjacent to the imaging device L0 is called L1, then the imaging device L0 has a symmetric imaging field of view, and the field of view of each imaging device L1 adjacent to the imaging device L0 is continuous with the field of view of the imaging device L0, therefore, through arranging a plurality of imaging devices, the range of the field of view of the imaging system can be expanded, to finally obtain an imaging system with a large field of view after splicing of the field of view.

In some embodiments, the imaging viewing angles of view of each imaging device L in the imaging system are the same. Under this condition, the imaging system can be used for acquisition of the optical field.

In some embodiments, the imaging viewing angles of view of each imaging device L in the imaging system are not completely identical, that is, at least two of the imaging devices L have the same imaging angle of view, and at least two of the imaging devices L have different imaging angles of view. In this case, the imaging system can be used for light field acquisition while serving to increase the imaging angle of view.

In some embodiments, in the imaging system, the pluralities of imaging devices L are arranged in an array.

Embodiments of the present disclosure provide an imaging lens, an imaging device and an imaging system. The imaging lens includes: a lens body, the lens body includes: a first optical surface and a second optical surface arranged in sequence along the incident direction of light; the first optical surface includes: an annular light incident area for transmitting the incident light; at least one first annular reflection area, the annular light incident area surrounds the first annular reflection area; the second optical surface includes: a light emitting area for transmitting the emitted light; at least one second annular reflection area, the second annular reflection area includes a light emitting area; the light is incident into the lens body from the annular light incident surface, and is reflected for a plurality of times between each second annular reflection surface and each first annular reflection surface in sequence, and is emitted outwards from the light emitting area to the lens body.

The above imaging lens, the imaging device and the imaging lens in the imaging system provided in embodiments of the present disclosure use only one lens, thereby simplifying the processing procedure and reducing the complexity of lens assembly. The multiple-reflection foldback light path can be used to reduce the optical length of the optical system, thereby significantly reducing the axial dimension of the imaging lens, such that the imaging lens has the characteristics of ultra-thinness and simple and compact structure.

Although preferred embodiments of the present disclosure have been described, additional changes and modifications may be made to these embodiments by those skilled in the art once the underlying inventive concepts are known. Therefore, the appended claims are intended to be construed to include the preferred embodiments and all the changes and modifications that fall within the scope of the present disclosure.

Obviously, those skilled in the art can make various modifications and variations to the embodiments of the present disclosure without departing from the spirit and scope of the present disclosure. Therefore, the present disclosure is also intended to encompass these modifications and variations thereto so long as the modifications and variations come into the scope of the claims of the present disclosure and their equivalents.

1. An imaging lens, comprising:
a lens body, comprising: a first optical surface and a second optical surface arranged in sequence along an incident direction of light;
wherein the first optical surface comprises:
an annular light incident area, for transmitting incident light; and
at least one first annular reflection area, surrounding the first annular reflection area;
wherein the second optical surface comprises:
a light emitting area, for transmitting emitted light; and
at least one second annular reflection area, surrounding the light emitting area; and
wherein the incident light is incident into the lens body through the annular light incident area, is reflected for a plurality of times between the at least one second annular reflection area and the at least one first annular reflection area in sequence, and is emitted outwards from the lens body through the light emitting area.

2. The imaging lens of claim 1, wherein the first optical surface is a curved surface, and the second optical surface is a flat surface.

3. The imaging lens of claim 2, wherein:
an imaging field of view of the imaging lens is a symmetrical field of view;
the annular light incident area is a centrally symmetrical structure;
the at least one first annular reflection area is a centrally symmetrical structure;
the at least one second annular reflection area is a centrally symmetrical structure; and
a central of symmetry of an orthographic projection of the at least one first annular reflection area on the second optical surface is coincided with a central of symmetry of the at least one second annular reflection area.

4. The imaging lens of claim 2, wherein:
an imaging field of view of the imaging lens is a non-symmetrical field of view; and
the annular light incident area is a non-centrally symmetrical structure;
the at least one first annular reflection area is a non-centrally symmetrical structure; and
the at least one second annular reflection area is a non-centrally symmetrical structure.

5. The imaging lens of claim 1, wherein an imaging field angle of view of the imaging lens is greater than or equal to 10°.

6. The imaging lens of claim 1, wherein:
a reflective coating film is disposed in an area, where the first annular reflection area is located, of the first optical surface; and
a reflective coating film is disposed in an area, where the second annular reflection area is located, of the second optical surface.

7. The imaging lens of claim 2, wherein a quantity of the first annular reflection area is equal to a quantity of the second annular reflection area.

8. The imaging lens of claim 7, wherein the quantity of the first annular reflection area ranges from 1 to 9, and the quantity of the second annular reflection area ranges from 1 to 9.

9. The imaging lens of claim 1, wherein an internal diameter dimension of the annular light incident area and an external diameter dimension of the annular light incident area satisfy a relationship as follows:
0.5≤α≤1;
wherein α represents a ratio of the internal diameter dimension of the annular light incident area to the external diameter dimension of the annular light incident area.

10. The imaging lens of claim 1, wherein:
a maximum thickness of the imaging lens along an optical axis direction is less than or equal to 2 mm;
a maximum size of the imaging lens along a direction vertical to the optical axis direction is less than or equal to 7 mm; and
a focal length of the imaging lens is less than or equal to 10 mm.

11. The imaging lens of claim 1, wherein a material of the lens body is polymethyl methacrylate.

12. The imaging lens of claim 1, wherein a working band of the imaging lens is a visible light band.

13. The imaging lens of claim 1, wherein the first optical surface comprises one of the first annular reflection area, and the second optical surface comprises one of the second annular reflection area.

14. The imaging lens of claim 13, wherein a surface shape of the annular light incident area and a surface shape of the first annular reflection area both satisfy a relationship as follows:
$$z = \frac{{cr}^{2}}{1 + \sqrt{1 - ( 1 + k ) {c}^{2} {r}^{2}}} + {\sum }_{i = 1}^{n} {α}_{i} {r}^{2 i} ;$$
wherein c represents a radius of a base sphere; k represents a constant of a conic curve; r represents a distance between any point in the annular light incident area or the first annular reflection area of the first optical surface and an aspherical axis; z represents a vertical distance corresponding to the any point in the annular light incident area or the first annular reflection area of the first optical surface, and the vertical distance is a distance between the any point in the annular light incident area or the first annular reflection area of the first optical surface and a tangent plane of the base sphere, closest to the any point, at a position at which the aspherical axis is intersected with the base sphere; αᵢ represents a coefficient, and n represents a positive integer; and
the aspherical axis is coincided with an optical axis.

15. The imaging lens of claim 14, wherein:
for the surface shape of the annular light incident area:
k=−0.6040;
α1=0;
α2=0.0054;
α3=−0.0038;
α4=0.0070;
α5=−0.0053;
α6=0.0019;
α7=−0.0003;
for the surface shape of the first annular reflection area:
k=7.19;
α1=0;
α2=−0.0207;
α3=0.0235;
α4=−0.1775;
α5=0.5615;
α6=−0.8856;
α7=0.5490.

16. The imaging lens of claim 15, wherein a radius of the base sphere of the annular light incident area is 2.00 mm; and a radius of the base sphere of the first annular reflection area is 11.21 mm;
a vertical distance a1 between a point on the equation Z=0 of the surface shape of the annular light incident area and the second optical surface is 1.81 mm; a vertical distance between a point on the equation Z=0 of the surface shape of the first annular reflection area and the second optical surface is 1.74 mm; and a maximum size of the imaging lens along a direction vertical to the optical axis is 2.8 mm; and
a focal length of the imaging lens is 4 mm.

17. An imaging device, comprising:
an annular diaphragm, for limiting an incident range of light;
the imaging lens according to claim 1, disposed on a side of the annular diaphragm and used for imaging; and
an optical detector, disposed on a side, facing away from the annular diaphragm, of the imaging lens, and configured to receive imaging light.

18. An imaging system, comprising a plurality of imaging devices of claim 17 arranged in an array.

19. The imaging system of claim 18, wherein imaging field angles of view of any two of the plurality of imaging devices are different, and the imaging field angles of view of adjacent imaging devices are continuous with each other; or,
the imaging field angles of view of each of the plurality of imaging devices are the same; or
the imaging field angles of view of at least two of the plurality of imaging devices are different.
